(19) United States
(12) Patent Application Publication
(10) Pub. No.: US 2014/0319854 A1
(43) Pub. Date: Oct. 30, 2014

(54) SINGLE PIECE LATCH

(71) Applicant: Carrier Corporation, Farmington, CT (US)

(72) Inventor: Barry W. Lee, Greenwood, IN (US)

(73) Assignee: Carrier Corporation, Farmington, CT (US)

(21) Appl. No.: 14/258,510

(22) Filed: Apr. 22, 2014

Related U.S. Application Data
(60) Provisional application No. 61/815,517, filed on Apr. 24, 2013.

(51) Int. Cl. E05B 1/00

(52) U.S. Cl. CPC E05B 1/0007
USPC 292/336.3

(57) ABSTRACT

A latch includes a latch head and a latch shaft ending from the latch head. A first pin pair extends radially outwardly from the latch shaft and is configured to secure a first panel between the latch head and the first pin pair. A second pin pair extends radially outwardly from the latch shaft and is configured to secure the first panel and a second panel between the latch head and the second pin pair and to release the first panel when the latch is turned 90 degrees. The second pin pair is angularly offset from the first pin pair by 90 degrees. The latch head, the latch shaft, the first pin pain and the second pin pair are a single-piece unitary structure.

### BACKGROUND

The subject matter disclosed herein generally relates to latches. More specifically, the disclosure relates to a single piece latch for securing a panel or door.

Currently, many types of latches are utilized to secure a door or panel in, for example, a heating, ventilation and air conditioning (HVAC) unit. Latches are provided to secure doors over, for example, a fan coil assembly or a filter. It is desired that the latches are robust to secure the panels or doors in place, while also being removable or openable to allow for access to components of the HVAC system for maintenance and/or repair. One type of latch is essentially a screw installed through holes in the door or panel and the frame or housing beneath to secure the door. This solution is low cost, but the holes in the doors and housing are prone to stripping, thus reducing the effectiveness of the latch. Further, the screws require tools for installation and removal. Another type of latch is a so-called quarter turn latch. The typical quarter turn latch is installed to the door, and held in place at the door by an additional retainer pin or clip installed at the door, often by a press or snap fit. Additionally, many such latches include a receptacle installed to the frame or housing. When the door is closed, the latch is rotated 90 degrees to secure the door in the closed position. The need for the additional retainer clip to secure the latch to the door adds cost and manufacturing time to the HVAC unit. Further the current quarter turn latch assemblies can be difficult to remove once installed, often resulting in damage to the door and/or housing in doing so.

### BRIEF DESCRIPTION

According to one embodiment, a latch includes a latch head and a latch shaft ending from the latch head. A first pin pair extends radially outwardly from the latch shaft and is configured to secure a first panel between the latch head and the first pin pair. A second pin pair extends radially outwardly from the latch shaft and is configured to secure the first panel and a second panel between the latch head and the second pin pair. The second pin pair is angularly offset from the first pin pair by 90 degrees. The latch head, the latch shaft, the first pin pain and the second pin pair are a single-piece unitary structure.

According to another embodiment, a door assembly includes a first panel including a first panel opening and a second panel including a second panel opening. A latch is insertable through the first panel opening and the second panel opening to secure the first panel to the second panel. The latch includes a latch head and a latch shaft ending from the latch head. A first pin pair extends radially outwardly from the latch shaft and is configured to secure the first panel between the latch head and the first pin pair. A second pin pair extends radially outwardly from the latch shaft and is configured to secure the first panel and the second panel between the latch head and the second pin pair. The second pin pair is angularly offset from the first pin pair by 90 degrees. The latch head, the latch shaft, the first pin pain and the second pin pair are a single-piece unitary structure.

According to yet another embodiment, a method of securing a first panel to a second panel includes inserting a latch into a first panel opening in a first panel, such that a first pin pair located along a latch shaft passes through the first panel opening. The latch is rotated by a first angle about a latch axis to retain the first panel between the first pin pair and a latch head. The latch is inserted into a second panel opening in a second panel, such that a second pin pain located along the latch shaft passes through the second panel opening. The latch is rotated by a second angle about the latch axis to retain the first panel and the second panel between the second pin pair and the latch head.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an embodiment of a door assembly;

FIG. 2 is a perspective view of an embodiment of a latch for a door assembly;

FIG. 3 is a perspective view of an embodiment of a latch installed to a door panel; and

FIG. 4 is a perspective view of an embodiment of a latch installed to a door assembly.

The detailed description explains embodiments of the invention, together with advantages and features, by way of example with reference to the drawings.

### DETAILED DESCRIPTION OF THE INVENTION

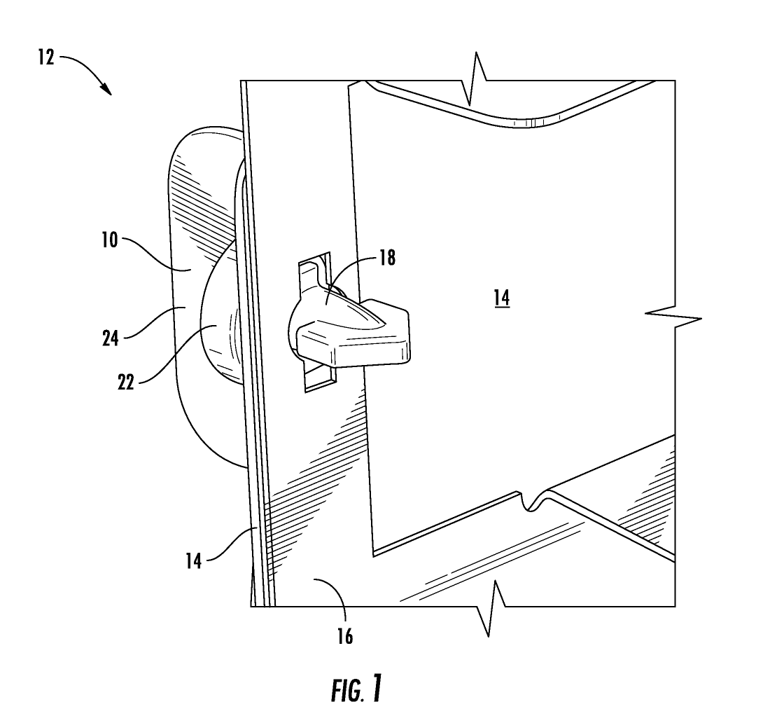

Shown in FIG. 1 is an embodiment of a latch 10 for door assembly 12 of a heating ventilation and air conditioning (HVAC) unit. The door assembly 12 includes a door panel 14 and a frame 16, which is a portion of an HVAC cabinet to which the door panel 14 is selectively attached. In some embodiments, the door assembly 12 is a burner door assembly, filter door assembly, fan coil door assembly, or the like. Further, while the description herein is in the context of a latch for a door assembly, it is to be appreciated that the latch 10 described herein may be utilized in other applications, for example, securing a removable panel to a housing.

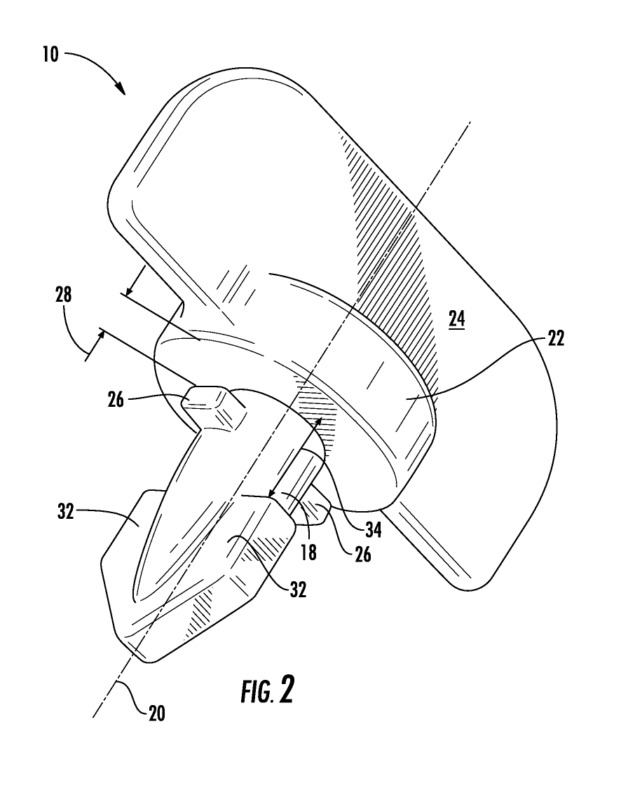

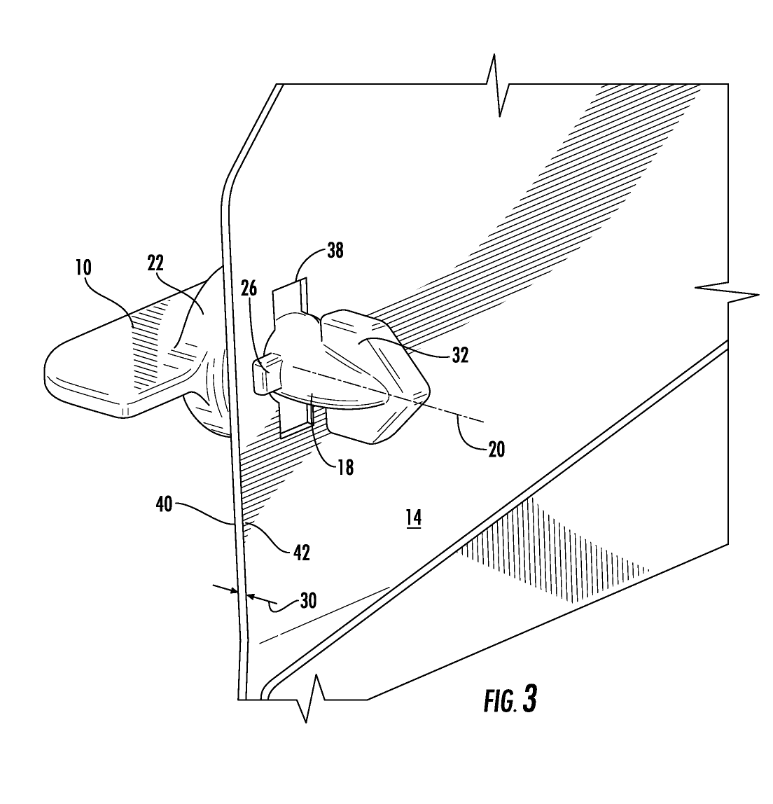

The latch 10 is shown in more detail in FIG. 2. The latch 10 includes a latch shaft 18 extending along a latch axis 20. In some embodiments, the latch shaft 18 is substantially cylindrical having a constant radius, while in other embodiments, such as shown in FIG. 2, the latch shaft 18 tapers with a decreasing radius along its length. At one end of the latch shaft 18, the latch 10 includes a latch head 22, which includes one or more features for rotating the latch 10 upon installation. For example, as shown in FIG. 2, the latch head 22 includes an upturned flange 24 to allow for rotating the latch with one's hand or fingers. In other embodiments, the latch head 22 may be configured with a screwdriver or hex socket for installation using such tools. The latch 10 further includes two sets of pins for securing the latch to the door panel 14 and to the frame 16. A first pair of pins, door pins 26 extend radially outwardly from the latch shaft 18 and are located at equal axial distances from the latch head 22 and are spaced from each other by 180 degrees, relative to the latch axis 20. A door pin distance 28 of the door pins 26 from the latch head 22 is equal to a door panel thickness 30 (shown in FIG. 3).

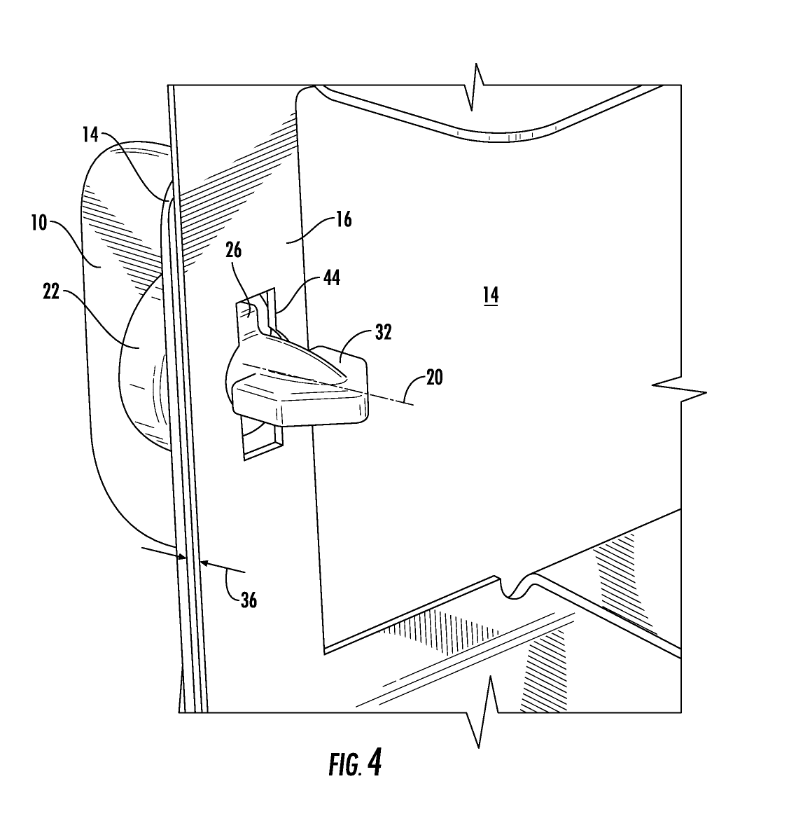

A second set of pins, frame pins 32, extend radially outwardly from the latch shaft 22 and are located at equal axial distances from the latch head 22. Further, a frame pin distance 34 of the frame pins 32 from the latch head 22, is equal to the door panel thickness 30 plus a frame thickness 36 (shown in FIG. 4). As shown, the frame pins 32 are spaced 180 degrees from each other, and are angularly offset from the door pins 26 by 90 degrees. In some embodiments, as shown in FIG. 2, the frame pins 32 are wedge-shaped or tapered along the latch axis 20 to ease installation into the door assembly 12.

Referring to FIGS. 3 and 4, installation of the latch 10 into the door assembly 12 will now be described. As shown in FIG. 3, the latch 10 is first installed to the door panel 14. This is accomplished by aligning the frame pins 32 with a door panel hole 38 in the door panel 14. In this embodiment, the door panel hole 38 is generally rectangular, but other door panel hole 38 shapes are contemplated within the scope of the present disclosure. The latch 10 is inserted into the door panel hole 38 so that the frame pins 32 pass entirely through the door panel hole 38. The latch 10 is then rotated 90 degrees so the door pins 26 align with the door panel hole 38. Similarly, the latch 10 is advanced through the door panel hole 38 until the door pins 26 pass entirely through. At this time the latch head 22 may contact the door panel 14. The latch 10 is then rotated another 90 degrees to take the door pins 26 out of alignment with the door panel hole 38. The latch 10 is thus secured to the door panel 14 by the latch head 22 on a first side 40 of the door panel 14 and the door pins 26 on a second side 42 of the door panel 14. As can be seen, the latch head 22 is configured such that the latch head 22 cannot pass through the door panel hole 38, and the door pins 26 are configured such that when rotated transverse to the door panel hole 38, as shown, the door pins 26 cannot pass through the door panel hole 38.

Referring now to FIG. 4, the latch 10 and door panel 14 are installed to the frame 16. To do so, the frame pins 32 are passed through a frame hole 44, which in some embodiments is a generally rectangular hole aligned with the door panel hole 38. In some embodiments, a frame hole 44 size approximately equals a door panel hole 38 size, with additional cutouts to allow door pins 26 to rotate in the plane of the door frame 16. Once the frame pins 32 are through the frame hole 44, the latch 10 is rotated an additional amount, preferably another 90 degrees, to secure the frame 16 and the door panel 14 together between the latch head 22 and the frame pins 32, thus securing the door assembly 12 in a closed position. In the closed position, the door pins 26 are no longer engaged to the door panel 14, so the frame pins 32 and the latch head 22 are carrying the loads of the assembly. Thus, in some embodiments, the frame pins 32 and/or the latch head 22 have a greater material thickness than the door pins 26.

To open the door assembly 12, the last portion of the process is reversed. The latch 10 is rotated such that the frame pins 32 are again aligned with the frame hole 44. Further, this rotation again engages the door pins 26 with the door panel 14 so that the latch 10 is secured thereto. The door panel 14 is then moved to an open position with the frame pins 32 passing through the frame 16. The latch 10 disclosed herein is beneficial at least in that it is a single piece configuration requiring no additional clip or retainer to secure the latch to the door panel, and further requires no additional socket installed to the frame into which the latch is installed, reducing manufacturing and installation costs. The latch 10 is durable, allowing for multiple openings and closures of the door assembly without damage to the door assembly. Further, the latch 10 may be easily removed and reinstalled without damage to the door panel or other components.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while the various embodiments of the invention have been described, it is to be understood that aspects of the invention may include only some of the described embodiments. Accordingly, the invention is not to be seen as limited by the foregoing description, but is only limited by the scope of the appended claims.

1. A latch comprising:
a latch head;
a latch shaft ending from the latch head;
a first pin pair extending radially outwardly from the latch shaft and configured to secure a first panel between the latch head and the first pin pair and to release the first panel when the latch is turned 90 degrees; and
a second pin pair extending radially outwardly from the latch shaft and configured to secure the first panel and a second panel between the latch head and the second pin pair, the second pin pair angularly offset from the first pin pair by 90 degrees;
wherein the latch head, the latch shaft, the first pin pain and the second pin pair are a single-piece unitary structure.

2. The latch of claim 1, wherein the latch head includes an upturned flange for gripping to operate the latch.

3. The latch of claim 1, where in a first distance between the latch head and the first pin pair is substantially equal to a thickness of the first panel.

4. The latch of claim 1, wherein a second distance between the latch head and the second pin pair is substantially equal to a sum of thicknesses of the first panel and the second panel.

5. The latch of claim 1, wherein the latch shaft is tapered along its length.

6. The latch of claim 1, wherein individual first pins of the first pin pair are spaced 180 degrees from each other.

7. The latch of claim 1, wherein individual second pins of the second pin pair are spaced 180 degrees from each other.

8. The latch of claim 1, where the second pin pair has a greater material thickness than the first pin pair.

9. The latch of claim 1, wherein individual second pins of the second pin pair are wedge-shaped or tapered.

10. A door assembly comprising:
a first panel including a first panel opening;
a second panel including a second panel opening; and
a latch insertable through the first panel opening and the second panel opening to secure the first panel to the second panel, the latch including:
a latch head;
a latch shaft extending from the latch head;
a first pin pair extending radially outwardly from the latch shaft and configured to secure the first panel between the latch head and the first pin pair and to release the first panel when the latch is turned 90 degrees; and
a second pin pair extending radially outwardly from the latch shaft and configured to secure the first panel and the second panel between the latch head and the second pin pair, the second pin pair angularly offset from the first pin pair by 90 degrees;
wherein the latch head, the latch shaft, the first pin pain and the second pin pair are a single-piece unitary structure.

11. The door assembly of claim 10, wherein a first distance between the latch head and the first pin pair is substantially equal to a thickness of the first panel.

12. The door assembly of claim 10, wherein a second distance between the latch head and the second pin pair is substantially equal to a sum of thicknesses of the first panel and the second panel.

13. The door assembly of claim 10, wherein individual second pins of the second pin pair are wedge-shaped or tapered.

14. The door assembly of claim 10, wherein the first panel opening and/or the second panel opening are substantially rectangular.

15. A method of securing a first panel to a second panel comprising:
inserting a latch into a first panel opening in a first panel, such that a first pin pair located along a latch shaft pass through the first panel opening;
rotating the latch by a first angle about a latch axis to retain the first panel between the first pin pair and a latch head;
inserting the latch into a second panel opening in a second panel, such that a second pin pain located along the latch shaft passes through the second panel opening; and
rotating the latch by a second angle about the latch axis to retain the first panel and the second panel between the second pin pair and the latch head.

16. The method of claim 15, wherein rotating the latch by the second angle releases the first panel from between the first pin pair and the latch head.

17. The method of claim 15, wherein the first angle and/or the second angle is 90 degrees.
